(19) United States
(12) Patent Application Publication
(10) Pub. No.: US 2020/0195393 A1
(43) Pub. Date: Jun. 18, 2020

(54) SYSTEM AND METHOD FOR POWER ALLOCATION IN SINGLE INPUT SINGLE OUTPUT ORTHOGONAL FREQUENCY DIVISION MULTIPLEXING COMMUNICATION SYSTEMS

(71) Applicant: Saudi Arabian Oil Company, Dhahran (SA)

(72) Inventor: Khalid A. ALSUHAILI, Dhahran (SA)

(21) Appl. No.: 16/219,122

(22) Filed: Dec. 13, 2018

(51) Int. Cl. H04L 5/00

(52) U.S. Cl. CPC H04L 5/0007; H04L 5/0058; H04L 5/0053

(57) ABSTRACT

A communication system and method for adaptively allocating power amongst OFDM subchannels. The exemplary algorithm enables each node to allocate transmit power in a water-filling-like fashion, but without reliance on channel state information feedback. Specifically, the algorithm involves two nodes communicating back-and-forth and, for each received signal, the receiving node calculating an updated estimate relating to the channel impulse response and subchannel transmit-gains. In an embodiment, the estimate is calculated based on a weighted combination of the previously calculated parameter estimate and the current received signal. Furthermore, from the updated estimate, capacity-optimizing subchannel transmit-gain weights are calculated and then used to transmit a signal back to the other node which also performs the power allocation steps. The power allocation algorithm is repeated by the nodes a suitable number of iterations for the respectively calculated subchannel transmit-gain weights to reach a near-optimal solution.

### FIELD OF THE INVENTION

The present invention relates to wireless communication systems, in particular, power allocation systems and methods for single input single output communication systems using Orthogonal Frequency Division Multiplexing.

### BACKGROUND OF THE INVENTION

Briefly, SISO (single input, single output) refers to a wireless communications system in which one antenna is used at the source (transmitter) and one antenna is used at the destination (receiver). In communications systems implementing Orthogonal Frequency Division Multiplexing (OFDM), an approach for maximizing the capacity of the channel is to selectively distribute power among the subchannels (i.e., subcarriers). A common method for distributing power among subchannels is to apply a water-filling algorithm that allocates greater amounts of power to subchannels having higher signal to noise ratio, thereby improving capacity. However, water-filling algorithms typically require knowledge of channel state information (CSI) that is fed-back from the receiving node to the transmitting node. In wireless communications, CSI refers to channel properties of a communication link. This information describes how a signal propagates from the transmitter to the receiver and represents the combined effect of, for example, power decay with distance, scattering and fading. The CSI makes it possible to adapt transmissions to current channel conditions, which facilitates achieving reliable communication with high data rates or, in other words, improved channel capacity.

Existing systems and methods for performing power allocation without CSI feedback between nodes either distribute power equally among subchannels or utilize complex equalizers. Generally speaking, the existing solutions are either suboptimal or overly complex.

What is needed is a power-allocation solution that can be implemented at a transmitting node and that effectively distributes power among OFDM subchannels in a water-filling like fashion without CSI feedback including the subchannel frequency response coefficients or the noise variance at the other communication node.

It is with respect to these and other considerations that the disclosure made herein is presented.

### SUMMARY OF THE INVENTION

According to an aspect of the present invention, a method for allocating power among subcarriers in a single input single output orthogonal frequency division multiplexing wireless communication system is provided. The method includes a first communication node receiving a signal that was transmitted over subcarriers by a second node and through a wireless communication channel. In addition, using the received signal and without reliance on channel state information, the first communication node calculates an estimate of a parameter which represents a product of a frequency response of the channel and a gain applied to respective subcarriers by the second node. In particular, the estimate is calculated as a function of the received signal and a previous estimate of the parameter. The method also includes a step in which the first node generates subcarrier transmit-gain weights for use in allocating transmit power among the subcarriers when transmitting signals by the first node. In particular, the subcarrier weights are calculated by the first node as a function of the calculated parameter estimate. In addition, the method includes the step of the first node weighting a second signal for transmission over said subcarriers according to said calculated subcarrier weights. Furthermore, the first node performs the step of transmitting the second signal, which has been weighted according said subcarrier weights, over the sub carriers.

In yet a further aspect, the method can also include a step wherein the second node receives the second signal and also performs the aforementioned calculating, generating, weighting and transmitting steps. Furthermore, the method can also include the first node and second node communicating back and forth and, for each received signal, respectively performing the receiving calculating, generating, weighting and transmitting steps and thereby adaptively updating the subcarrier weights with each iteration.

According to another aspect of the present invention, single input single output (SISO) wireless orthogonal frequency division multiplexing (OFDM) communication system comprising a first SISO OFDM communication node is provided. In particular, the first node comprises a receiver that is configured to receive signals transmitted over subcarriers including a first signal transmitted by a second node through a wireless communication channel. The first node also includes a power allocation module, which is encoded in a processing engine of the first node.

The power allocation module includes an estimation module that configures the processing engine to calculate, from the received signal without reliance on channel state information from the second node, an estimate of a parameter which represents a product of a frequency response of the channel and a gain applied to respective subcarriers by the second node. More specifically, the parameter estimate is calculated as a function of the received signal and a previous estimate of the parameter. The power allocation module also includes a subcarrier weight generator that configures the processing engine to calculate subcarrier transmit-gain weights for use in allocating transmit power among the subcarriers when transmitting signals. More specifically, the subcarrier weights are calculated as a function of the calculated parameter estimate. The power allocation module also includes a subcarriers weighting module configured to weight a second signal for transmission over said subcarriers according to said calculated subcarrier weights. In addition, the first node includes a transmitter configured to transmit the second signal weighted according said subcarrier weights over the sub carriers.

According to a further aspect, the SISO OFDM communication system also includes a second SISO OFDM communication node comprising a respective instance of the receiver, the power allocation module and the transmitter. Furthermore, the first and second node can be configured to execute an iterative power allocation algorithm which causes the first and second node to communicate back and forth a plurality of iterations. Moreover, with each received signal, the receiving node adaptively updates the subcarrier weights by re-calculating the estimate of the parameter, re-calculating subcarrier transmit-gain weights and then transmitting a signal weighted according to the re-calculated subcarrier weights back to the other node.

These and other aspects, features, and advantages can be appreciated from the accompanying description of certain embodiments of the invention and the accompanying drawing figures and claims.

### BRIEF DESCRIPTION OF THE DRAWING FIGURES

FIG. 1 is a high-level block diagram of an exemplary SISO OFDM system communication system;

FIG. 2A is a block diagram illustrating exemplary OFDM transmitter and receiver structures of the system of FIG. 1 and respective operations;

FIG. 2B is a block diagram further illustrating the exemplary OFDM system of FIG. 1 and noting the existence of the interference-free parallel sub channels in the frequency domain and the channel frequency response and additive noise of the channel;

FIG. 3 is a block diagram illustrating an exemplary OFDM transceiver configured to perform power allocation in accordance with one or more embodiments of the invention;

FIG. 4 is a block diagram of an exemplary transceiver wherein an exemplary algorithm for allocating subchannel gains in accordance with one or more embodiments of the invention is represented mathematically;

FIG. 5 is a high-level flow-diagram illustrating a power-allocation algorithm implemented by the OFDM nodes in accordance with one or more embodiments of the invention;

FIG. 6 is a graph illustrating the frequency response of a random realization of the multipath channel generated in connection with testing an exemplary power-allocation algorithm in accordance embodiments of the invention;

FIG. 7A is a graph illustrating the power allocated to subchannels generated in connection with testing an exemplary power allocation algorithm in accordance with one or more embodiments of the invention;

FIG. 7B is a graph illustrating the power allocated to subchannels generated in connection with testing an ideal water filling algorithm;

FIG. 8A, is a graph illustrating the performance of the exemplary power allocation algorithm relative to an ideal water-filling algorithm generated in connection with testing under specific test parameters, specifically σ²=1/128 and μϵ{1,2,5,10};

FIG. 8B, is a graph illustrating the performance of the exemplary power allocation algorithm relative to an ideal water-filling algorithm generated in connection with testing under specific test parameters, specifically σ²=5/128 and μϵ{1,2,5,10};

FIG. 8C, is a graph illustrating the performance of the exemplary power allocation algorithm relative to an ideal water-filling algorithm generated in connection with testing under specific test parameters, specifically σ²=10/128 and μϵ{1,2,5,10};

FIG. 8D, is a graph illustrating the performance of the exemplary power allocation algorithm relative to an ideal water-filling algorithm generated in connection with testing under specific test parameters, specifically σ²=100/128 and μϵ{1,2,5,10};

FIGS. 9A-D depict charts generated in connection with simulating and testing the performance of the exemplary power allocation algorithm for a particular colored noise test scenario; and

FIGS. 10A-D depict charts generated in connection with simulating and testing the performance of the exemplary power allocation algorithm for a particular colored noise test scenario.

### DETAILED DESCRIPTION OF CERTAIN EMBODIMENTS OF THE INVENTION

By way of overview and introduction, a communication system and iterative algorithm is disclosed for distributing transmit-power amongst OFDM subchannels in a water-filling-like fashion, without any express feedback of CSI from the receiver to the transmitter.

Generally, the SISO system of the proposed invention comprises two transceiver nodes that are configured to iteratively and reciprocally communicate (i.e., back-and-forth) over a reciprocal multi-path channel using OFDM. The SISO OFDM channel can be viewed as a MIMO channel where the channel impulse response is diagonal, accordingly, exemplary embodiments of the invention disclosed herein can exploit the diagonality of the channel and the correlation in the frequency domain. Specifically, embodiments of the invention apply an iterative algorithm that is capable of distributing the transmitted power amongst the OFDM subchannels (i.e., by selectively allocating gain amongst the subchannels) in a water-filling-like fashion by estimating the product of the channel impulse response and the transmit gains and updating those gains such that the capacity is maximized.

In accordance with the disclosed embodiments, each node is also configured to apply the exemplary algorithm for allocating power among subchannels in a capacity-optimizing manner. As further described below, steps of the power allocation algorithm include, with each received signal, the receiving node calculating an “estimate” of a parameter. The parameter represents the product of the channel response and subcarrier gains, which were applied to the signal by the transmitting node. The estimate of the parameter is calculated as a function of a previously calculated parameter estimate and the current received signal. More specifically, the previous estimate and current received signal are differentially weighted according to a cost function, which serves to place a greater weight on the previous estimate than on the current received signal. Furthermore, based on the updated estimate, capacity-optimizing transmit-gain weights are calculated for each of the subchannels. The transmit-gain weights are then used to transmit a signal back to the other node which, in-turn, performs the power allocation steps. The back-and-forth communication and power allocation is performed iteratively by the two nodes. By repeating the process a suitable number of iterations, the subchannel transmit-gain weights calculated by the nodes, respectively, converge on a near-optimal solution without reliance on express feedback of CSI between nodes.

As noted, existing power-allocation systems that are not reliant on CSI feedback between nodes either distribute power equally among subchannels or utilize complex equalizers and are either suboptimal or overly complex. There are also technical drawbacks to traditional water-filling algorithms in that they require CSI feedback in order to function properly. The exemplary power allocation systems and methods disclosed herein present technical improvements addressing the drawbacks of existing systems and provide practical benefits in that they do not require equalizers and effectively distribute power among subchannels in a water-filling like fashion without the need to know the subchannel frequency response coefficients or the noise variance at the other communication node.

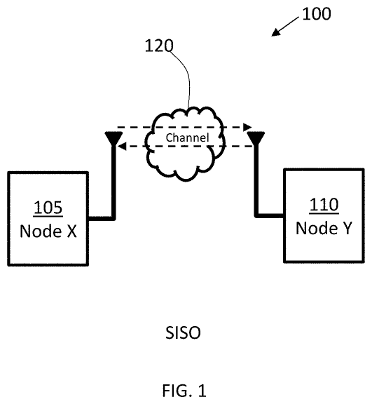

FIG. 1 illustrates an exemplary communication system 100, which can be used in conjunction with exemplary embodiments of the present invention. The system 100 is, for example, a SISO system that includes two nodes, namely Node X 105 and Node Y 110. The nodes can respectively communicate over a multi-path wireless channel 120. Preferably the channel in the forward and reverse directions are reciprocal. Each of the nodes 105 and 110 can include a transceiver among other components, as further described in detail below. In accordance with the disclosed embodiments, the system 100 is configured to communicate using OFDM.

For the purpose of background and to illustrate the exemplary embodiments of the present invention, following is a brief discussion of the theoretical model of the exemplary communication system 100 within which embodiments of the invention can be implemented.

### Model SISO OFDM System

Orthogonal frequency-division multiplexing (OFDM) is a combination of modulation and multiplexing. OFDM is a frequency-division multiplexing (FDM) scheme utilized as a digital multi-carrier modulation method. A large number of closely-spaced orthogonal subcarriers are used to carry data. The data is divided into several parallel data streams or channels, one for each subcarrier. Each subcarrier is modulated with a conventional modulation scheme (such as quadrature amplitude modulation or phase-shift keying) at a low symbol rate, maintaining total data rates similar to the conventional single-carrier modulation schemes in the same bandwidth.

OFDM has emerged as a popular scheme for wideband digital communication, whether wireless or wired, used in applications such as digital television and audio broadcasting, wireless networking and broadband internet access. The primary advantage of OFDM over single-carrier schemes is its ability to cope with severe channel conditions (for example, attenuation of high frequencies in a long copper wire, narrowband interference and frequency-selective fading due to multipath) without complex equalization filters. Channel equalization is simplified because OFDM may be viewed as many slowly-modulated narrowband signals rather than one rapidly-modulated wideband signal. The low symbol rate makes the use of a guard interval between symbols affordable, making it possible to handle time-spreading and eliminate inter-symbol interference (ISI).

OFDM in its primary form is considered as a digital modulation technique, and not a multi-user channel access method, since it is utilized for transferring one bit stream over one communication channel using one sequence of OFDM symbols. However, OFDM can be combined with multiple access using time, frequency or coding separation of the users.

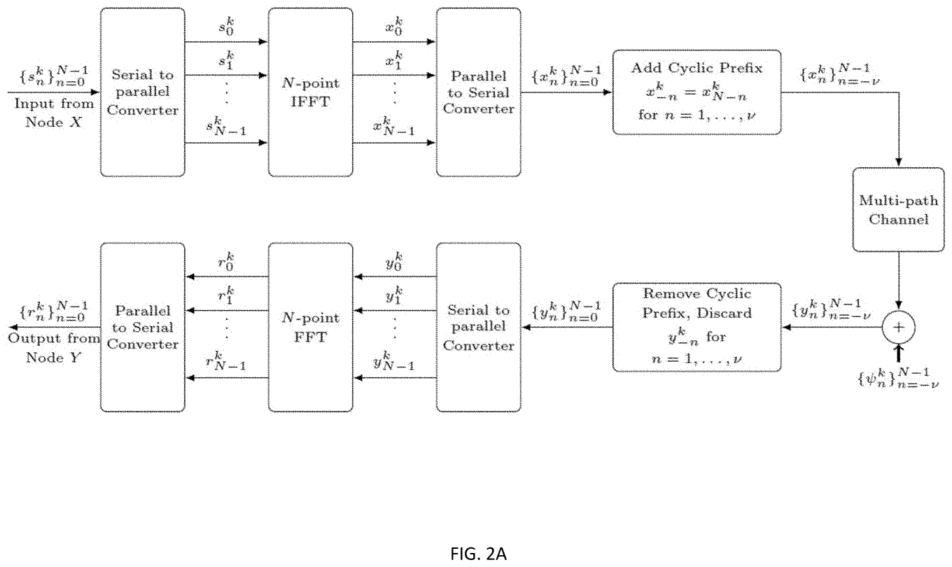

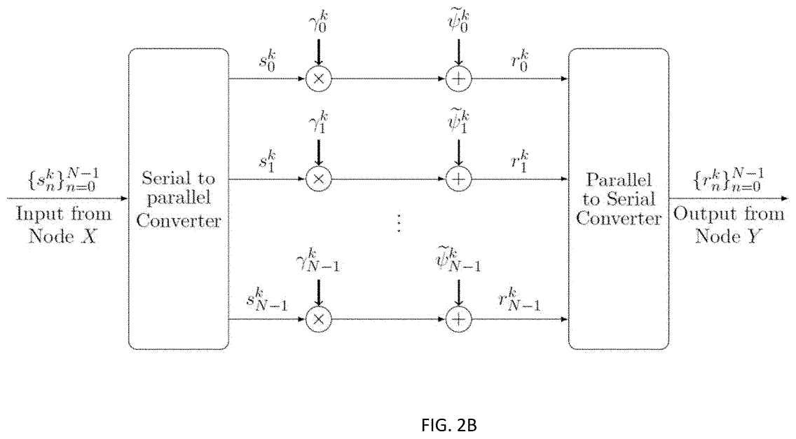

The details of the exemplary OFDM transmitter and receiver structures are presented in FIG. 2A and are further described herein. It is noted that the OFDM systems basically involve transmission of a cyclic prefixed signal over a fading multipath channel. For clarity, small bolded letters are used to reference vectors and capital bolded letters reference matrices. The set of m-dimensional complex vectors are shown by [symbol] m and [symbol] m×n shows the set of m×n complex matrices. The i^{th} column of matrix A is shown with [A]ⁱ and [A]ⁱⁱ shows the (i, j)^{th} entry of A. The k dimensional identity matrix is denoted by Iₖ. Notations ∥·∥, (·)^{T}, (·)* and (·)^{H} are used for the Frobenius norm, transpose, conjugate and hermitian of a vector/matrix, respectively.

The frequency domain input symbols {sₙ^{l}}ₙ₌₀^{N-1} denote the k^{th} OFDM transmit symbol. These symbols may come for instance from an M-QAM constellation. N denotes the number of OFDM subcarriers (the number of constellation symbols to be transmitted in one OFDM symbol). After serial to parallel conversion of the input constellation symbol stream, an N-point IFFT is taken to get {xₙ^{k}}ₙ₌₀^{N-1} (the time domain transmit symbols). After back parallel to serial conversion, a cyclic redundancy of length v (the number of CP samples) is added as a prefix in such a way that x₋ₙ^{k}=x_{N-n}^{k} for n=1,2, . . . , v. The signal is then transmitted on a multipath channel with the Channel Impulse Response (CIR) of the multipath channel of length L denoted here by the vector:

h=[h₀h₁. . . h_{L-1}]^{T}_{ϵ} [symbol] ^{L}. (1)

For the simplicity of presentation and without limitation, the CP length is assumed that to be greater than the CIR length. The incorporation of CP property (x₋ₙ^{k}=x_{N-n}^{k} for n =1,2, . . . , v) for the case of CIR being shorter than the duration of CP leads to the following equation:

$$\begin{matrix}[ \begin{matrix}{y}_{0}^{k} \\ {y}_{1}^{k} \\ ⋮ \\ ⋮ \\ ⋮ \\ {y}_{N - 1}^{k}\end{matrix} ] = [ \begin{matrix}{h}_{0} & 0 & ⋯ & 0 & {h}_{L - 1} & ⋯ & {h}_{1} \\ ⋮ & ⋱ & ⋱ & & ⋱ & ⋱ & ⋮ \\ ⋮ & & ⋱ & ⋱ & & ⋱ & {h}_{L - 1} \\ {h}_{L - 1} & & & ⋱ & ⋱ & & 0 \\ 0 & ⋱ & & & ⋱ & ⋱ & ⋮ \\ ⋮ & ⋱ & ⋱ & & & ⋱ & 0 \\ 0 & ⋯ & 0 & {h}_{L - 1} & ⋯ & ⋯ & {h}_{0}\end{matrix} ] [ \begin{matrix}{x}_{o}^{k} \\ {x}_{1}^{k} \\ ⋮ \\ ⋮ \\ ⋮ \\ {x}_{N - 1}^{k}\end{matrix} ] + {Ψ}^{k} \\ = {H}_{CIRC} {x}^{k} + {Ψ}^{k}\end{matrix} \qquad ( 2 )$$

It is noted that the effective N×N channel matrix, H_{CIRC}, now gets circulant, i.e., its rows are circularly shifted versions of each other. This results in simplifications, described below, once the receiver, as shown in FIG. 2A, takes the FFT after CP removal. Note however, that this circulant nature of the effective channel matrix is void if the channel is time variant, because in that case the CIR coefficients appearing in a row (corresponding to a sample of the OFDM symbol) are potentially different than the CIR coefficients appearing in some other row. Thus, for the case of sufficient Cyclic Prefix and time-invariant channel, the OFDM system can be described by the following relationship in the frequency domain after the receiver removes the CP and performs the FFT operation,

r^{k}=FH_{CIRC}F^{H}ₛ^{k}+\tilde{Ψ}^{k}, (3)

where F ϵ [symbol] ^{N×N} is the Fourier matrix (unitary in nature, i.e. FF^{H}=I_{N}). The vectors s^{k}, r^{k}, \tilde{Ψ}^{k} ϵ [symbol] ^{N} are frequency domain versions of x^{k}, Y^{k}, Ψ^{k} ϵ [symbol] ^{N} and are obtained by linear transformations via the Fourier matrix, as evident from the diagram in FIG. 2A. Now because the eigenvalue decomposition of a circulant matrix such as H_{CIRC} can be given as

H_{CIRC}=F^{H}ΓF, (4)

where F is the unitary Fourier matrix and the diagonal matrix Γ ϵ C^{N×N} is defined to be a diagonal matrix containing the Channel Frequency Response (CFR) coefficients along its main diagonal (the eigenvalues of the circulant matrix), which can be given in this case as

$$Γ = diag ( F [ \begin{matrix}h \\ {0}_{N - L}\end{matrix} ] ) {=}^{Δ} diag ( H ) . \qquad ( 5 )$$

Substituting (4) and (5) in the system model (3) yields

r^{k}=Γs^{k}+\tilde{Ψ}^{k}. (6)

Note that the fading multipath channel is separated into N interference-free parallel subchannels, whereby each of the received subcarrier can be given as the corresponding transmitted subcarrier scaled by a scalar complex fading coefficient (CFR at that subcarrier) and corrupted by the additive noise. The detection scheme at the receiver can, in some implementations, be to divide the received symbols by the estimated CFR. FIG. 2B depicts the block diagram of the equivalent OFDM system model, noting the existence of the interference-free parallel subchannels in the frequency domain. Specifically, in the block diagram of the equivalent OFDM system shown in FIG. 2, sₙ^{k} and rₙ^{k} are the n^{th} elements of the transmitted and received vectors respectively, whereas γₙ^{k} and \tilde{Ψ}ₙ^{k} are the CFR coefficient of the n^{th} subchannel and the noise sample associated with that subchannel, respectively.

There are similarities between the equivalent OFDM channel here, and the equivalent channel of a MIMO single user channel as shown and described in Gazor, S., & AlSuhaili, K (2010, July). Communications over the Best Singular Mode of a Reciprocal MIMO Channel Communications, IEEE Transactions on, 58(7), 1993-2001 (“NPL Gazor-AlSuhaili”), with the exception that the directions of the subchannels are known in the OFDM case. Thus, while certain multimode algorithms such as the one proposed in NPL Gazor-AlSuhaili, are capable of estimating the CFR coefficients as they correspond to the eigenvalues (equivalently, the singular values) of the N×N diagonal channel ϵ, such algorithms are lacking. The exemplary embodiments of the invention provide a more sophisticated approach that is not only configured to estimate parameters relating to the channel coefficients, but is also configured to determine how much power should be assigned to every subchannel in order to improve the channel capacity.

Accordingly, for the purpose of illustration and non-limiting example only, an exemplary SISO OFDM system configured to implement a closed loop power-allocation algorithm according to one or more embodiments of the invention is further described herein in the context of the model SISO OFDM system 100 described above. As further discussed herein the exemplary system and closed loop power-allocation algorithm enables communicating nodes X and Y to allocate power amongst the OFDM subchannels in a water-filling-like fashion without reliance on CSI feedback.

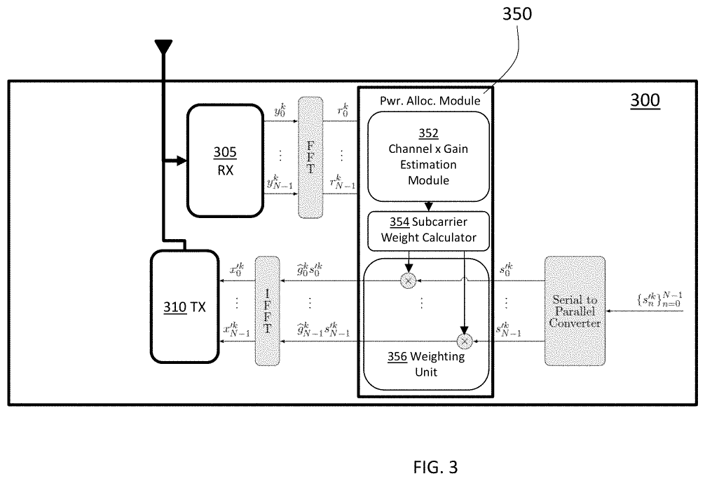

FIG. 3 schematically illustrates a functional block diagram of an OFDM transceiver 300 that is configured to perform power allocation in accordance with the exemplary embodiments of the invention. While transceiver 300 might be described as being implemented at Node Y 110, it should be understood that both Node Y and Node X 105 preferably include a transceiver 300, respectively, thereby enabling joint implementation of the exemplary power allocation algorithm, as further described herein.

As shown, the transceiver 300 can comprise a receiver (RX) component 305 and a transmitter (TX) component 310. For simplicity, the RX and TX components represent the analog receive and transmit hardware as well as additional analog and digital signal processing components of known SISO OFDM nodes for instance, a parallel to serial converter and cyclic prefix adding/subtracting units, a standard OFDM subcarrier modulation mapping unit (not shown). It should be understood that, in addition to the components specifically described herein, the exemplary transceiver 300 can include any components of a SISO OFDM transceiver or transmitter and receiver system, as are known in the art.

According to a salient aspect, transceiver 300 includes a power allocation module 350 (“PAM”) functionally operating between the receiving and transmitting components of the transceiver. The PAM can be implemented using any combination of hardware and/or software, as might be desired. In one exemplary configuration, the PAM is implemented using the digital baseband processing engine of the transceiver. Generally, the PAM is configured to perform operations including, estimating salient parameters from received signal, including the product of the channel frequency response and subcarrier gains, calculating subcarrier transmit-gain weights, and utilizing the subcarrier weights to allocate power among the subcarriers for transmitting a signal from Node Y to another node, e.g., Node X. FIG. 3 further illustrates an exemplary, non-limiting, configuration of the PAM in which these three primary operations are performed by the estimation module 352, subcarrier weight calculator 354 and weighting unit 356, respectively.

As noted, in accordance with exemplary embodiments of the invention, the two nodes of the SISO communication system, Node X 105 and Node Y 110 can include a transceiver 300, respectively, and can be configured to implement the adaptive power-allocation algorithm that involves iteratively and reciprocally communicating (i.e., back-and-forth) over the channel 120 and, with each received signal, performing the additional steps of the power allocation algorithm further described herein.

Generally, the power allocation algorithm involves, with each received signal, the receiving node estimating one or more parameters or properties relating to the channel and the received signal. In an exemplary embodiment, the estimated parameter represents the product of the frequency response of the channel and transmit gains applied to the signal (e.g., the subcarrier gains pre-applied to the transmitted symbol at Node X before transmission to Node Y). According to a salient aspect, the parameter estimate can be calculated as a function of the difference between a previous estimate and the current received signal. The power-allocation algorithm also includes calculating updated transmit weights for each of the subchannels based on the updated parameter estimate.

Thereafter, the receiving node utilizes the updated transmit weights to transmit a signal back to the other node, which similarly performs the parameter estimation and transmit weight determination steps. Accordingly, the exemplary power-allocation algorithm can be iteratively repeated by Nodes X and Y and, with each exchange, the nodes each incrementally and adaptively updating their respective parameter estimate and transmit weights such that the gains allocated amongst the subchannels converges to a steady state and capacity optimizing solution. It should be understood that the step for calculating the estimate of the parameter can also be referred herein to as “updating” or calculating an “updated” estimate, because parameter a function of a previously calculated estimate or a pre-defined parameter (e.g., as defined during initialization). Similarly, because the transmit weights are calculated with each received signal based on previously calculated weights or pre-defined weights, the step for calculating transmit weights is also referred to as “updating” or calculating updated transmit weights.

It should be understood that the nodes can be configured to implement various algorithmic approaches for defining how many iterations are performed by the nodes. For instance, in some exemplary configurations, the nodes can be configured to perform the power-allocation algorithm a pre-defined number of iterations. By way of further example, the nodes can be configured to iterate until the calculated weights reach relatively stable values. By way of further example, the nodes can be configured iterate until the capacity of the channel reaches a prescribed level, as can be measured by one or more of the nodes using techniques known in the art. In addition, it should be further understood that the power allocation algorithm can be implemented intermittently, periodically or continuously during communication between nodes. For instance, in one configuration, the nodes can be configured to halt execution of the power-allocation algorithm after reaching a suitable power-allocation solution. Accordingly, the nodes can be configured to transmit data there-between using the previously determined capacity-optimizing transmit-weights. Furthermore, it should be understood that the nodes can be configured to perform the power allocation algorithm periodically thereby adaptively updating the power-allocation solution to account for changing conditions. For example and without limitation, the power-allocation algorithm can be implemented at prescribed intervals and/or upon the occurrence of certain events or conditions (e.g., at the beginning of each communication session between two nodes, or when the measured quality of communications falls below a prescribed level). In view of the foregoing, it can be further appreciated that the nodes can be configured to exchange messages and commands that serve to control and coordinate the joint implementation of the exemplary power-allocation algorithm by the nodes.

It should be understood that, in some implementations, the aforementioned steps of the power allocation algorithm can also be preceded by one or more initialization steps by which the nodes X and Y define an initial parameter estimate and subchannel transmit weights that can then be updated as described above.

The exemplary systems and methods for performing power allocation will be further appreciated in view of the following detailed discussion of the exemplary SISO OFDM system 100 model, represented by equation (6), but modified in accordance with the exemplary embodiments of the invention. For simplicity the exemplary system and steps of the power allocation algorithm is described in the context of Node X transmitting an OFDM symbol to Node Y over the channel in the X→Y direction and Node Y performing the parameter estimation and subchannel gain calculation steps based on the received signal.

Specifically, in accordance with the exemplary embodiments of the invention, the transmitting Node X is configured to introduce the gains, gₙ^{k} for n=1, . . . , N−1, by which the k^{th} transmitted OFDM symbol is pre-multiplied, resulting in the following model

$$\begin{matrix}{r}^{k} = {G}^{k} Γ {s}^{k} + {\tilde{Ψ}}^{k} \\ = {Π}^{k} {s}^{k} + {\tilde{Ψ}}^{k}\end{matrix} \qquad ( 7 )$$

where G^{k} ϵ [symbol] ^{N×N} is a diagonal matrix incorporating the gains gₙ^{k} for n=1, . . . , N−1 as the elements on the main diagonal, s^{k} denotes the kth OFDM transmit symbol transmitted from Node X, r^{k} denotes the received kth OFDM symbol received at Node Y, Γ is a diagonal matrix containing the Channel Frequency Response (CFR) coefficients along its main diagonal, and ilk is the product of G^{k} and Γ, \tilde{Ψ}^{k} denotes the added noise sample of the channel.

Accordingly, to provide an adaptive filter at the receiving node, Node Y, configured to estimate the parameters πₙ^{k} for n=1, . . . , N−1, where πₙ^{k} is the n^{th} element on the diagonal of Π^{k}, then s^{k} can be regarded as the input and r^{k} as the desired response. As noted, the transceiver can be configured to calculate an estimate of the parameter as a function of a previous estimate of the parameter. More specifically, at time k (or equivalently, at the time of receiving the k^{th} OFDM symbol), the transceiver can form an estimate of r^{k}, denoted by \hat{r}^{k}=\hat{Π}^{k}s^{k}. At each iteration, the transceiver can be configured to update \hat{Π}^{k} using the step Δ=\hat{Π}^{k}−\hat{Π}^{k-1}. Furthermore, the transceiver can be configured to put more weight on the previous estimate than on the current received signal in order to combat the impact of the additive noise at the expense of the convergence rate. To this end, in an exemplary configuration, the following cost function can be utilized, the minimization of which satisfies the above requirements:

$$\{ \begin{matrix}f ( Π ) = μ {‖ Π - {\hat{Π}}^{k - 1} ‖}^{2} + {‖ {r}^{k} - Π {s}^{k} ‖}^{2} , \\ {\hat{Π}}^{k} = arg {min}_{Π} ( f ( Π ) ) ,\end{matrix} \qquad ( 8 )$$

where μ is a parameter that is preferably greater than one to ensure that more weight is put on the previous estimate. Then, the transceiver can use the resulting \hat{Π}^{k} in the following optimization problem that maximizes the capacity of the diagonal channel Γ

$$\{ \begin{matrix}\begin{matrix}{C}_{Y \to X} ( {\hat{Π}}^{k} ) = {\sum }_{n = 0}^{N - 1} log [ 1 + \frac{{\vert {\hat{Π}}_{n , n}^{k} \vert}^{2}}{{σ}_{n}^{2}} ] \\ = {\sum }_{n = 0}^{N - 1} log [ 1 + \frac{{( {G}_{n , n}^{k} )}^{2} {\vert {Γ}_{n , n} \vert}^{2}}{{σ}_{n}^{2}} ]\end{matrix} \\ {\hat{G}}^{k} = arg {max}_{{G}^{k}} {C}_{Y \to X} ( {G}^{k} ) \\ s . t . {\sum }_{n = 0}^{N - 1} {( {\hat{G}}_{n , n}^{k} )}^{2} = {P}_{0} ,\end{matrix} \qquad ( 9 )$$

where C_{Y→X} denotes the capacity of the reverse channel (the channel from Node Y to Node X), the superscript, k, represents the time of receiving the k^{th} OFDM symbol, the subscript, (n,n), denotes the n^{th} element on the main diagonal of the diagonal matrices which corresponds to the n^{th} subchannel, σₙ² is the noise variance of the n^{th} subchannel, and P₀ is average of the available power at Node Y. It is noted that the calculation of the capacity in (9) requires the knowledge of the noise variance of each subchannel at Node X and the transmit gains at Node Y. However, equation (8) serves to estimate the product of the CFR coefficients and the transmit gains at Node X. In addition, assuming the reciprocity of the forward channel and the reverse channel and that the noise variances of the subchannels are equal at both nodes, the optimization problem in equation (9) can be solved and the subscript of the capacity function, Y→X dropped.

The unconstrained optimization problem represented in equation (8) can be solved by forming the gradient of f; equate it to zero and solve for \tilde{Π}^{k} which results in

$${\hat{π}}_{n}^{k} = \frac{μ {\hat{π}}_{n}^{k - 1} + {r}_{n}^{k} {s}_{n}^{{k}^{*}}}{μ + {\vert {s}_{n}^{k} \vert}^{2}} , ∀ n = 0 , … , N - 1 \qquad ( 10 )$$

where \hat{π}ₙ^{k} [symbol] \hat{Π}_{n,n}^{k}, rₙ^{k} is the n^{th} element of the received vector r^{k} and sₙ^{k} and sₙ^{k}* are the n^{th} element and the complex conjugate of the n^{th} element of transmitted vector s^{k} respectively. Now the constrained optimization problem represented in equations (9) can be solved by forming the Lagrangian of (9) and equating the gradient of the Lagrangian with respect to the pair (G^{k}; λ) to zero, where λ represents the Lagrange multiplier. This yields

$${( {\hat{g}}_{n}^{k} )}^{2} = \frac{1}{λ} \frac{{\vert {\hat{π}}_{n}^{k} \vert}^{2}}{{σ}_{n}^{2} + {\vert {\hat{π}}_{n}^{k} \vert}^{2}} , ∀ n = 0 , … , N - 1 , \qquad ( 11 )$$

where ̂gₙ^{k} [symbol] Ĝ_{n,n}^{k}. Substituting (11) in the constraint of (9) yields

$$λ = \frac{1}{{P}_{0}} {\sum }_{n = 0}^{N - 1} \frac{{\vert {\hat{π}}_{n}^{k} \vert}^{2}}{{σ}_{n}^{2} + {\vert {\hat{π}}_{n}^{k} \vert}^{2}} . \qquad ( 12 )$$

Substituting (12) back in (11) yields the following capacity-optimal transmit weights at Node Y

$${\hat{g}}_{n}^{k} = \sqrt{\frac{{\vert {\hat{π}}_{n}^{k} \vert}^{2}}{{σ}_{n}^{2} + {\vert {\hat{π}}_{n}^{k} \vert}^{2}}} {( \frac{1}{{P}_{0}} {\sum }_{m = 0}^{N - 1} \frac{{\vert {\hat{π}}_{m}^{k} \vert}^{2}}{{σ}_{m}^{2} + {\vert {\hat{π}}_{m}^{k} \vert}^{2}} )}^{\frac{- 1}{2}} ∀ n = 0 , … , N - 1. \qquad ( 13 )$$

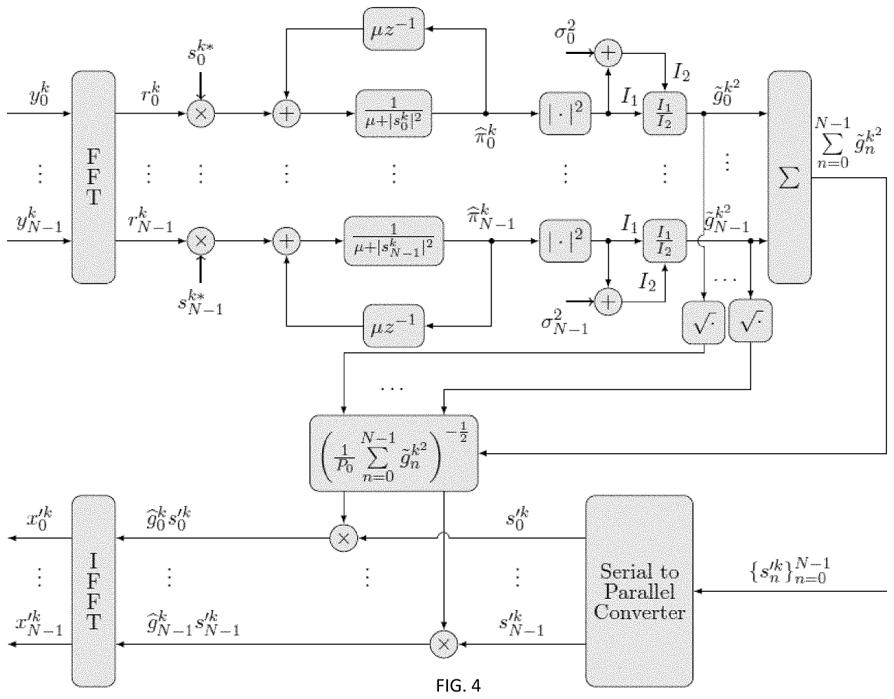

FIG. 4 is a block diagram of the exemplary transceiver 300, wherein the various operations of the power-allocation module 350 are represented mathematically to illustrate the exemplary algorithmic approach for allocating subchannel gains (as seen at Node Y). In other words, FIG. 4 depicts the operations that the exemplary transceiver at Node Y is configured to perform while employing the proposed power allocation algorithm. The functions of Node X would be represented by a similar block diagram with the exception that {sₙ^{tk}}ₙ₌₀^{N-1} is replaced by {sₙ^{k}}ₙ₌₀^{N-1}, {xₙ^{tk}}ₙ₌₀^{N-1} is replaced by {xₙ^{k}}ₙ₌₀^{N-1}, {rₙ^{k}}ₙ₌₀^{N-1} is replaced by {rₙ^{tk}}ₙ₌₀^{N-1} and {yₙ^{k}}ₙ₌₀^{N-1} is replaced by {yₙ^{tk}}ₙ₌₀^{N-1}.

It should be noted that, in the exemplary power allocation algorithm described herein, it is assumed that the OFDM symbols sent by both nodes are all-ones vectors. This is to reduce the complexity of the algorithm for purposes of illustration. However, it should be understood that OFDM data other than an all-ones vectors can be transmitted in accordance with the disclosed embodiments of the invention. For instance, in some implementations the data transmitted during power-allocation can be another constant vector. In addition or alternatively, the data transmitted can be a constant or changing vector that is known by both nodes. In addition or alternatively, the data can be unknown at the nodes.

An exemplary implementation of the power allocation algorithm described above and depicted in FIG. 4 is further shown and described in the following Table 1. Table 1 summarizes the iterative steps of using the power-allocation algorithm by Nodes X and Y including an exemplary initialization process.

TABLE 1
Summary of the power allocation algorithm.

| | |
|---|---|
| Node X | Node Y |

Initialization

| | |
|---|---|
| Allocate equal gains gₙ⁰ × 1/\sqrt{N} and | Receive r_{y}⁰ = Π_{y}⁰ + \tilde{Ψ}_{y}⁰. |
| send it through the OFDM channel Γ, note that the transmit vector is all ones vector. | ${\hat{\prod }}_{y}^{0} ← diag ( {r}_{y}^{0} ) ; {G}_{y}^{0} ← diag ( \frac{{r}_{y}^{0}}{‖ {r}_{y}^{0} ‖} ) .$ |
| Receive rₓ⁰ = Πₓ⁰ + \tilde{Ψ}ₓ⁰. | Send G_{y}⁰ through the OFDM channel |
| ${\hat{\prod }}_{x}^{0} ← diag ( {r}_{x}^{0} ) ; {G}_{x}^{0} ← diag ( \frac{{r}_{x}^{0}}{‖ {r}_{x}^{0} ‖} ) .$ | Γ, note that the transmit vector is all ones vector. |

Estimation of πₙ^{k} and gₙ^{k}

| | |
|---|---|
| Send Gₓ^{k} through the OFDN channel Γ. | Receive r_{y}^{k} = Π_{y}^{k} + \tilde{Ψ}_{y}^{k} |
| Receive rₓ^{k} = Πₓ^{k} + \tilde{Ψ}ₓ^{k}. | Send G_{y}^{k} through the OFDN channel Γ. |
| Use (10) and (13) to update \hat{π}ₙ^{k} and ĝₙ^{k}. | Use (10) and (13) to update \hat{π}ₙ^{k} and ĝₙ^{k}. |

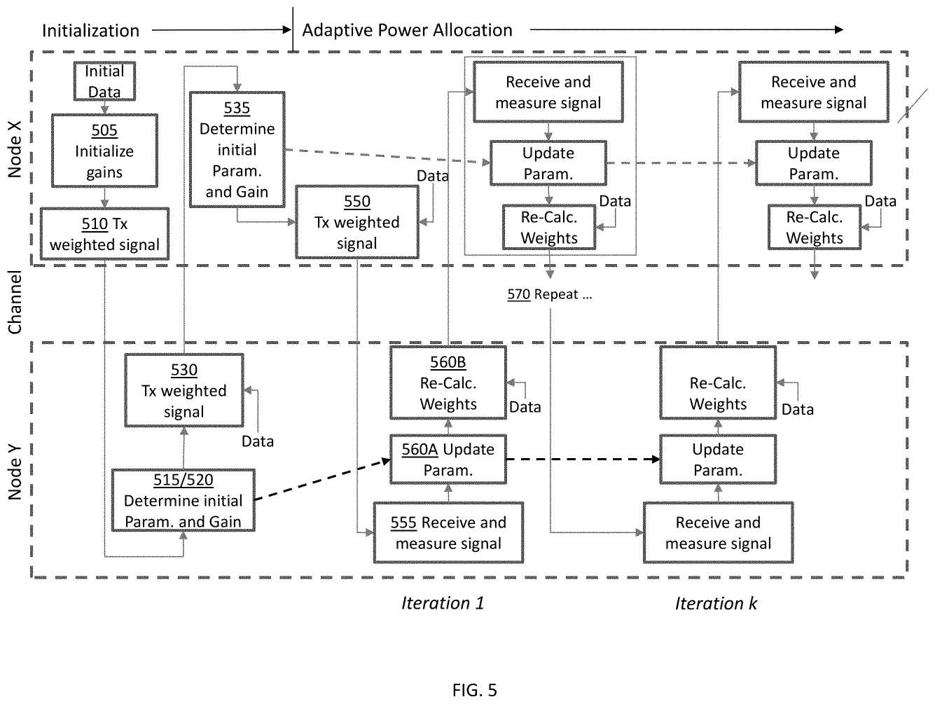

FIG. 5 is a high-level flow-diagram further illustrating the exemplary steps of the power-allocation algorithm performed by Node X and Node Y, including the initialization process, and subsequent iterations of the power allocation algorithm. For example and without limitation, the exemplary process shown in FIG. 4 and described herein begins at Node X.

At step 505, Node X allocates gains among the N subchannels equally in view of a total power. For instance, the subcarrier weight calculator 364 can configure the processing engine to allocate equal gains among the subchannels according to the equation.

gₙ⁰=1\sqrt{N}.

At step 510, Node X pre-multiplies the data to be sent by the allocated gains. This step can be performed, for example, by the weighting unit 365. In some implementations, the data to be sent can comprise an all-ones vector. In addition Node X transmits the resulting signal sₓ⁰, over the OFDM channel, Γ, in the X→Y direction. As would be understood by those in the art, the transmission can be performed using the Tx component 305 of the transceiver 300.

At step 515, Node Y receives r_{y}⁰. As would be understood by those in the art, receipt of the transmitted signal can involve measuring the received signal at each subchannel by the receiving transceiver, particularly, using the Rx component 305, for example.

At step 520, based on r_{y}⁰, Node Y determines \hat{Π}^{k}, which denotes the product of the gain and channel response. In addition, at step 425, Node Y determines G_{y}⁰, which denotes the diagonal matrix incorporating the gains, gₙ⁰ for each subchannel n=1. . . N−1 as the elements along its main diagonal. The determinations at step 520 and 525 can be made using the following equations, for example:

$${\hat{Π}}_{y}^{0} ← diag ( {r}_{y}^{0} ) ; {G}_{y}^{0} ← diag ( \frac{{r}_{y}^{0}}{‖ {r}_{y}^{0} ‖} ) \qquad ( 14 )$$

As noted, calculation of the parameters and gains in the exemplary initialization process can be performed based on the assumption at the receiving node that the transmitting node transmitted an all ones vector.

At step 530, Node Y pre-multiplies an OFDM data symbol comprising an all-ones vector by the determined G_{y}⁰. The result, which is effectively G_{y}⁰, can then be transmitted through the channel in the Y→X direction.

At step 535, Node X receives rₓ⁰ and forms a respective initial estimate of the parameter and gain matrix represented in the following equations:

$${\hat{Π}}_{x}^{0} ← diag ( {r}_{x}^{0} ) ; {G}_{x}^{0} ← diag ( \frac{{r}_{x}^{0}}{‖ {r}_{x}^{0} ‖} ) \qquad ( 15 )$$

The foregoing initialization process serves to define an initial estimate of \hat{Π}^{k}, and G^{k} at each Nodes X and Y, respectively. It should be understood that alternative initialization steps could be implemented. In addition, a joint initialization process can be avoided altogether. For instance, in some implementations initialization can involve each node respectively defining a prescribed or arbitrary initial “estimate” of \hat{Π}^{k}, and G^{k} that can then be adaptively refined through performance of the power allocation algorithm.

Subsequent to initialization, Node X and Y can iteratively repeat the power-allocation algorithm and, with each iteration, respectively update the parameter estimate and transmit weights such that the allocation of gains amongst subchannels converges to a steady state and capacity optimizing solution.

More specifically, at step 550, Node X sends Gₓ^{k} through channel to Y. For example, at iteration k=1, . . . after initialization, Node X is sending Gₓ⁰ (from initialization). In particular, Node X can be configured to multiply the data to be sent by the previously determined gain matrix Gₓ^{k}. This step can be performed, for example, by the weighting unit 365. In some implementations, the data signal to be weighted and sent can comprise an all-ones vector. In addition, at step 550, Node X transmits the resulting signal sₓ⁰, over the OFDM channel, Γ, in the X→Y direction.

At step 555, Node Y receives r_{y}¹, using for instance, the transceiver 300 provided at Node Y. As would be understood step 555 for receiving the signal can include processing the received signal, including, removing the cyclic prefix of the received signal, performing a serial to parallel conversion and N-point FFT to obtain r_{y}¹. In addition, in connection with step 560, the transceiver can be configured to measure the subchannels and determine the noise variance per subchannel σₙ².

Specifically, at step 560A, Node X calculates an updated estimate of the parameter πₙ^{k} for respective subchannels using equation 10, as previously described and shown below

$${\hat{π}}_{n}^{k} = \frac{μ {\hat{π}}_{n}^{k - 1} + {r}_{n}^{k} {s}_{n}^{{k}^{*}}}{μ + {\vert {s}_{n}^{k} \vert}^{2}} , ∀ n = 0 , … , N - 1. \qquad ( 10 )$$

Then at step 560B, based on the result of step 560A, Node X calculates a capacity-optimizing transmit weights (i.e., gain) for each of the subchannels using equation (13), as previously described and shown below:

$${\hat{g}}_{n}^{k} = \sqrt{\frac{{\vert {\hat{π}}_{n}^{k} \vert}^{2}}{{σ}_{n}^{2} + {\vert {\hat{π}}_{n}^{k} \vert}^{2}}} {( \frac{1}{{P}_{0}} {\sum }_{m = 0}^{N - 1} \frac{{\vert {\hat{π}}_{m}^{k} \vert}^{2}}{{σ}_{m}^{2} + {\vert {\hat{π}}_{m}^{k} \vert}^{2}} )}^{\frac{- 1}{2}} ∀ n = 0 , … , N - 1. \qquad ( 13 )$$

Thereafter, at step 570, Node Y transmits a data signal pre-multiplied by the estimated subcarrier transmit-weights calculated at Step 560B through the channel to Node X. In the exemplary embodiment in which the data signal is an all ones vector, Node Y effectively transmits a signal representing G_{y}^{k} to Node X, wherein G_{y}^{k} denotes the diagonal matrix incorporating the estimated gains for each subchannel n=1. . . N−1 as the elements along its main diagonal, over the channel to Node X.

Similarly, at step 570, Node X, receives the signal transmitted from Node Y, rₓ¹, and performs steps 560A and 560B to update Node X's respective estimate of Π and G based on the received signal.

Node X and Y can then repeat steps 550-570 a suitable number of iterations such that the nodes' respective allocation of gains amongst subchannels converges to a steady state and capacity optimizing solution.

In following test cases, the performance of the exemplary power allocation algorithm is demonstrated using computer simulations for white and colored noise scenarios. In performing these evaluations it has been assumed that the two nodes are allocated N=2^{r} (where r is a positive integer) subchannels plus the length of the cyclic prefix. The coefficients of the CIR are generated as i.i.d. complex Gaussian random variables with zero mean and unit variance. We calculate the CFR of the OFDM channel by taking the N-FFT of the CIR. FIG. 4 shows the frequency response of a random realization of the multipath channel with length L=8 assuming that the transceivers use 128 subchannels plus the length of the cyclic prefix.

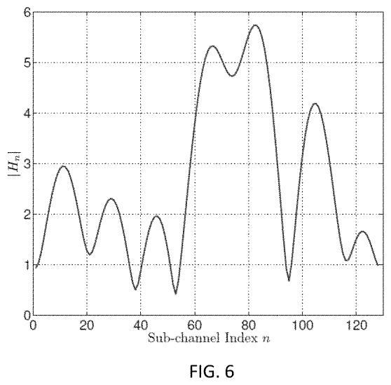

FIG. 6 illustrates the frequency response of the random realization of the multipath channel with length L=8.

### Test Case 1—The Performance in Presence of White Noise

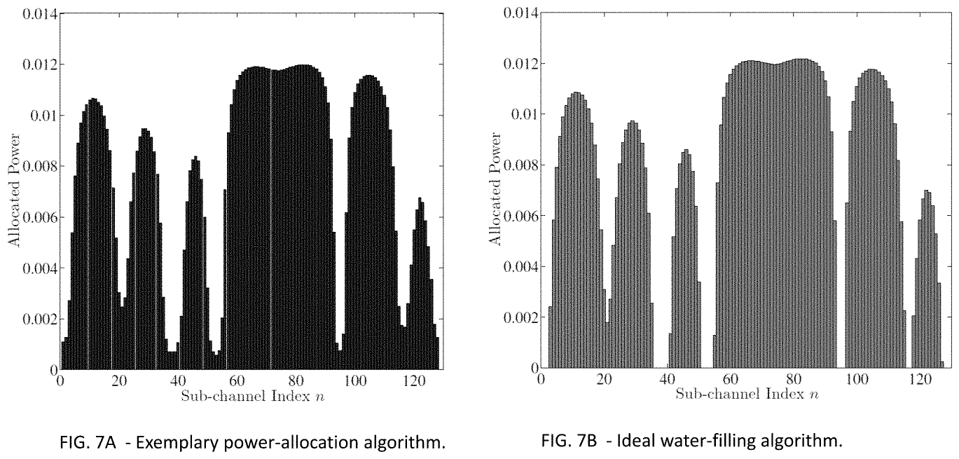

In this test, the power allocation algorithm was initialized with equal gains. FIG. 7A depicts the allocated power to each subchannel using the exemplary power allocation algorithm with the following parameters: N=128, L=8, P₀=1, and σₙ²=2/128 (this is equivalent to saying that in case of using a single carrier utilizing the whole bandwidth, then the transmit power to noise ratio will be −3 dB). By comparison, FIG. 7B depicts the power allocation using an ideal water-filling algorithm, where the additive noise is white with a variance of 2/128 per subchannel. In other words, in the case of performing power allocation using an ideal water-filling algorithm, the transmitter knows perfectly the CFR coefficients as well as the noise variance at the receiver.

It is worth noting the similarity of the results of the power allocation algorithm and the water-filling algorithm. However, the exemplary power-allocation algorithm is a closed loop algorithm that does not require any feed-back from the receiver about the channel state information. Furthermore, to the extent the simulation of the power allocation algorithm did not completely eliminate the transmit power in the weak subchannels, as achieved by the optimal water-filling algorithm, the power-allocation algorithm can be adapted to eliminate weaker subchannels. One exemplary approach for eliminating weaker subchannels is to configure the transceiver to categorize any channel that is allocated power less than a prescribed percentage of the power of the strongest subchannel, as a weak subchannel and, as a result, eliminate the weak subchannel. For instance, a weak subchannel can be eliminated by defining a zero (0) transmit weight for the weak subchannel. Another exemplary approach for eliminating weaker subchannels is to increase the value of μ, which achieves the resulting effect of configuring the power-allocation algorithm to allocate more power to stronger subchannels.

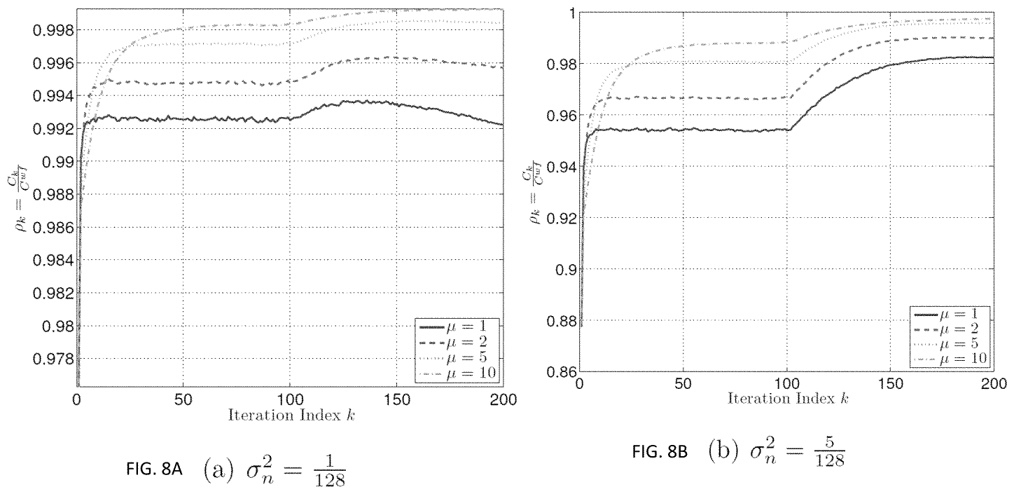

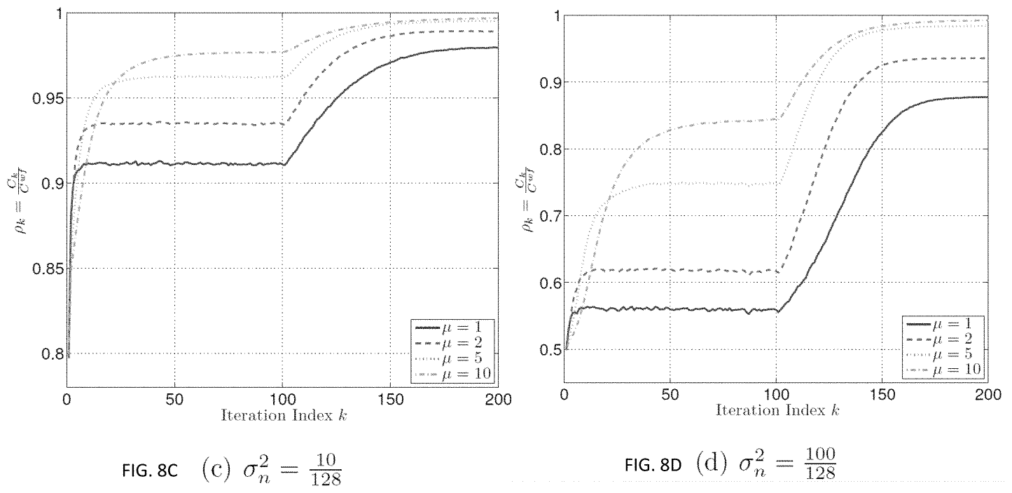

To quantify the performance of the exemplary power allocation algorithm, the capacity of the system employing the power allocation algorithm is compared to the capacity of the same system that distributes the power using the water-filling algorithm. In other words, the following relation is considered to be the performance measure

$${ρ}_{k} = \frac{{C}^{k}}{{C}^{wf}} , \qquad ( 14 )$$

where C^{wf} the capacity of the OFDM system employing the water-filling algorithm and Cₖ is the capacity of the OFDM system (at iteration k or at the time of processing the k^{th} OFDM symbol) employing the exemplary power allocation algorithm. FIG. 8A, which was generated by simulating and plotting, the performance curves as defined by (14) for the same aforementioned scenario with different noise variances per subchannel and different values of μ using the power allocation algorithm for 200 iterations. In the first 100 iterations the exemplary power allocation algorithm was implemented and did not employ any subchannel elimination strategy. In the second 100 iterations the power allocation algorithm was implemented and employed a 1% subchannel elimination strategy. That is, the algorithm was configured such that any subchannel that is allocated power that is less than 1% of the power allocated to the strongest subchannel was eliminated.

In particular, for the simulations represented in FIGS. 8A-8D, respectively, the following parameters were prescribed σₙ²=1/128, 5/128, 10/120, and 100/128 (this is equivalent to saying that in case of using a single carrier utilizing the whole bandwidth, then the transmit power to noise ratio will be 0, −7, −10,and −20 dB respectively); and μ ϵ {1,2,5,10}. In other words, FIG. 8A-8D show a comparison of the ratio of the capacity of the OFDM system employing the power allocation algorithm to the capacity of the same system employing the water-filling algorithm as defined by (14) for different values of σ² and μ.

From the performance curves of 8A-8D, it can be noted that there is an increase in the capacity as a function of the iteration index compared to the initial capacity associated with equal power allocation. It also can be noted that as the value of μ is increased, the performance of the power-allocation algorithm results are closer to the capacity of the optimal water-filling power allocation algorithm, as the effect of increasing μ is the same as eliminating weaker subchannels, which is evident in the same figure. However, the convergence rate to the steady state is inversely proportional to the value of μ. It is also worth noting that the significance of the exemplary power allocation algorithm increases as the noise level increase. The explanation is that as the noise increases, a larger number of weaker subchannels are preferably excluded in order to utilize the allocated power in stronger sub channels to increase the channel capacity.

### Test Case 2—The Performance in Presence of Colored Noise

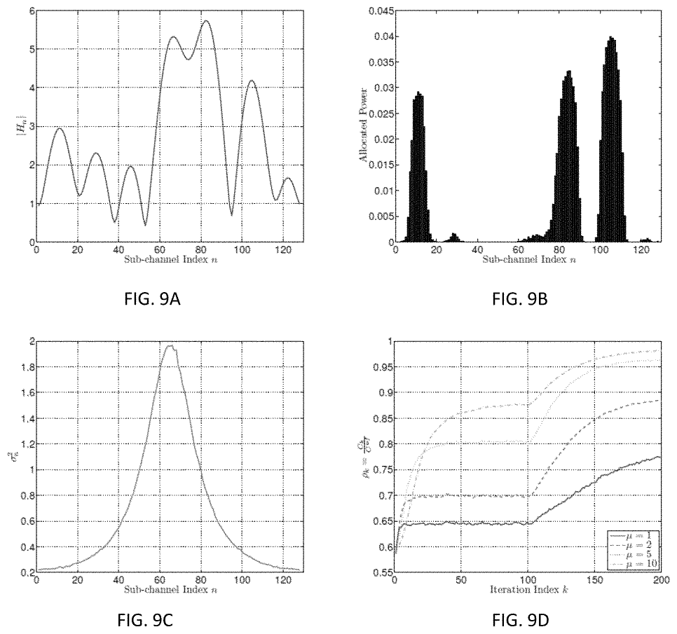

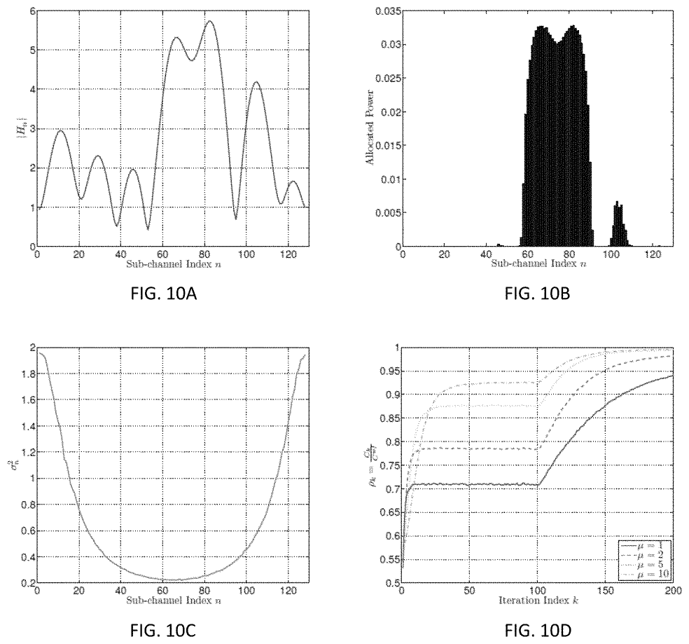

The simulations and tests further described herein consider the same basic parameters for testing the exemplary power allocation algorithm as in Test Case 1, but in the presence of colored noise. Specifically, performance of the exemplary power allocation algorithm under two colored noise scenarios were evaluated: the first is when the noise density is higher in the middle of the band than in the edges (see e.g., chart (c) of FIG. 9) and the second is when the noise density in the edges of the band is higher than that in the middle (see e.g., chart (c) of FIG. 10). In the simulations, both kinds of noise were generated using the following relations Ψ^{k}=½(w^{k}−Ψ^{k-1}) and Ψ^{k}=½(w^{k}+Ψ^{k-1}), respectively, where wₖ is an N-normal complex vector with i.i.d Gaussian entries of zero mean and unit variance per dimension. In both scenarios the power-allocation algorithm was initialized with equal gains and the exemplary power allocation algorithm was implemented.

FIG. 9, includes various charts generated in connection with the simulations and tests performed for the first noise scenario, specifically, a greater concentration of noise power in the middle of the communication band. In particular, FIG. 9 chart (a) depicts the absolute value of the multi-channel CIR; chart (b) depicts the power distribution amongst the subchannels using the power-allocation algorithm in the scenario where there is more concentration of noise power in the middle of the communication band; chart (c) depicts the noise variance at each subchannel; and chart (d) depicts the performance of the algorithm as defined by equation (14) for different values of μ.

FIG. 10, includes various graphs generated in connection with the simulations and tests performed for the second noise scenario, namely, when there is a greater concentration of noise power in the edges of the communication band. In particular, FIG. 10 chart (a) depicts the absolute value of the multi-channel CIR, chart (b) depicts the power distribution amongst the subchannels using the exemplary power-allocation algorithm in the scenario where there is more concentration of noise power in the edges of the communication band; and chart (c) depicts the noise variance at each subchannel, and chart (d) depicts the performance of the algorithm as defined by equation (14) for different values of μ.

In both cases, the results show the same behavior exhibited in the case of the white noise, which confirms the effectiveness of the exemplary power-allocation algorithm in both white and colored noise environments.

As can be appreciated, the foregoing simulations and test results illustrate the benefits of the power-allocation systems and methods in accordance with embodiments of the present invention in the scenario of a SISO OFDM system. The computer simulations, further verify that the resulting capacity when implementing the exemplary power-allocation systems and algorithms is very close to the open-loop water-filling algorithm, without the need to know the channel state information nor the noise variance at the other node. The simulations further show that the algorithm works well in both white and colored noise environments.

Although the scope of the present invention is not limited in this regard, simulations and theoretical calculations have shown that the exemplary power-allocation systems and algorithms in accordance with embodiments of the present invention can improve channel capacity similar to a water-filling algorithm, but without reliance on express CSI feedback. The practical benefit of the proposed invention is further illustrated by the exemplary simulation results further described herein.

It should be understood that various combination, alternatives and modifications of the present invention could be devised by those skilled in the art. The present invention is intended to embrace all such alternatives, modifications and variances that fall within the scope of the appended claims.

It should be understood that embodiments of the present invention may be implemented by software, by hardware, or by any combination of software and/or hardware as may be appropriate for specific applications or design requirements. In some embodiments, the system of the invention can further include general, multi-purpose and/or specific processors, circuits, logic systems, operators, circuitry, blocks, units and/or sub-units that can perform any operation, or any combination of operations, described above. In some embodiments of the invention, the system can further include memory units, buffers and/or registers for temporary and/or permanent storage of data. These units (e.g., processor and memory units), or any combination thereof, can be referred to herein as “circuitry,” and can be internal and/or external to a communication node, in whole or in part. Accordingly, embodiments of the invention can include an article comprising a storage medium having stored thereon instruction that, when executed by a processing device, perform the steps of the exemplary power allocation algorithm for allocating transmission power at a communication node by, inter alia, multiplying one or more of a plurality of subcarriers by a calculated respective subcarrier weight, in accordance with the disclosed embodiments.

The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be further appreciated that more or fewer operations can be performed than shown in the figures and described. It is to be understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been particularly shown and described with reference to a preferred embodiment thereof, it will be understood by those skilled in the art that various changes in form and details may be made therein without departing from the spirit and scope of the invention. Therefore, the scope of the invention is indicated by the appended claims, rather than by the foregoing description. All changes that come within the meaning and range of equivalency of the claims are to be embraced within their scope

What is claimed is:

1. A method for allocating power among subcarriers in a single input single output orthogonal frequency division multiplexing wireless communication system:
receiving, at a first communication node, a signal transmitted over subcarriers, wherein the signal is transmitted by a second node through a wireless communication channel;
calculating, by the first node from said received signal and without reliance on channel state information from the second node, an estimate of a parameter that represents a product of a frequency response of the channel and a gain applied to respective subcarriers by the second node, wherein the estimate is calculated as a function of the received signal and a previous estimate of the parameter;
generating, by the first node, subcarrier transmit-gain weights for use in allocating transmit power among the subcarriers when transmitting signals by the first node, wherein said subcarrier weights are calculated as a function of the calculated parameter estimate;
weighting, by the first node, a second signal for transmission over said subcarriers according to said calculated subcarrier weights; and
transmitting, by the second node over the subcarriers, the second signal weighted according said sub carrier weights.

2. The method of claim 1, further comprising:
performing, by the second node based on the second signal, the receiving, calculating, generating, weighting and transmitting steps.

3. The method of claim 2, wherein the first node and second node communicate back and forth and respectively perform the receiving calculating, generating, weighting and transmitting steps based on each received signal, thereby adaptively updating the subcarrier weights with each back and forth iteration.

4. The method of claim 3, wherein the power allocation method is performed a number of iterations that is sufficient for the subchannel weights calculated by the first and second nodes, respectively, to reach a steady-state and capacity-optimizing solution.

5. The method of claim 1, wherein the updated parameter estimate is calculated using a function that places a greater weight on the previous parameter estimate than the received signal.

6. The method of claim 5, wherein the updated parameter estimate is calculated for respective subcarriers according to the following equation
$${\hat{π}}_{n}^{k} = \frac{μ {\hat{π}}_{n}^{k - 1} + {r}_{n}^{k} {s}_{n}^{{k}^{*}}}{μ + {\vert {s}_{n}^{k} \vert}^{2}} , ∀ n = 0 , … , N - 1 ,$$
wherein superscript k, represents a time of receiving the signal and n denotes a given sub carrier among N total subcarriers of the channel, \hat{π}ₙ^{k} denotes the updated parameter estimate for the n^{th} subchannel, μ is a weighting parameter that is greater than one, r^{k} denotes the signal vector received at a given node, and rₙ^{k} is the n^{th} element of the received signal vector r^{k}, and sₙ^{k} and sₙ^{k}* are the n^{th} element and the complex conjugate of the n^{th} element of transmitted signal vector s^{k} and wherein s^{k} is known.

7. The method of claim 5, wherein the subcarrier weights for respective subcarriers are calculated according to a function for optimizing a capacity of the channel.

8. The method of claim 7, wherein the subcarrier weights for respective subcarriers are calculated according to the following equation:
$${\hat{g}}_{n}^{k} = \sqrt{\frac{{\vert {\hat{π}}_{n}^{k} \vert}^{2}}{{σ}_{n}^{2} + {\vert {\hat{π}}_{n}^{k} \vert}^{2}}} {( \frac{1}{{P}_{0}} {\sum }_{m = 0}^{N - 1} \frac{{\vert {\hat{π}}_{m}^{k} \vert}^{2}}{{σ}_{m}^{2} + {\vert {\hat{π}}_{m}^{k} \vert}^{2}} )}^{\frac{- 1}{2}} ∀ n = 0 , … , N - 1$$
wherein superscript, k, represents a time of receiving the signal,
n denotes a given subcarrier among N total subcarriers of the channel,
σₙ² is the noise variance of the n^{th} subchannel,
σₘ² is the noise variance of the m^{th} subchannel,
\hat{π}ₙ^{k} a denotes the updated parameter estimated for the n^{th} subchannel, and
P₀ is the average of the available power at the node calculating the subcarrier weights.

9. A single input single output (SISO) wireless orthogonal frequency division multiplexing (OFDM) communication system, comprising:
a first SISO OFDM communication node comprising:
a receiver configured to receive signals transmitted over subcarriers, including a first signal transmitted by a second node through a wireless communication channel;
a power allocation module encoded in a processing engine of the node, the power allocation module including:
an estimation module that configures the processing engine to:
determine, from the received signal without reliance on channel state information from the second node, calculate an estimate of a parameter which represents a product of a frequency response of the channel and a gain applied to respective sub carriers by the second node, wherein the parameter estimate is calculated as a function of the received signal and a previous estimate of the parameter,
a sub carrier weight generator that configures the processing engine to calculate subcarrier transmit-gain weights for use in allocating transmit power among the subcarriers when transmitting signals by the first node, wherein said subcarrier weights are calculated as a function of the calculated parameter estimate, and
a subcarriers weighting module configured to weight a second signal for transmission over said subcarriers according to said calculated subcarrier weights; and
a transmitter configured to transmit the second signal weighted according said subcarrier weights over the sub carriers.

10. The system of claim 9, further comprising:
the second node, wherein the second node is a SISO OFDM communication node comprising a respective instance of the receiver, the power allocation module and the transmitter.

11. The system of claim 10, wherein the first and second node are configured to execute an iterative power allocation algorithm which causes the first and second node communicate back and forth a plurality of iterations and, with each received signal, the receiving node adaptively updates the subcarrier weights by re-calculating the estimate of the parameter, and re-calculating subcarrier transmit-gain weights, followed by transmitting a signal weighted according to the re-calculated subcarrier weights back to the other node.

12. The system of claim 11, wherein the power allocation algorithm is implemented a number of iterations sufficient for the calculated subcarrier transmit-gain weights to converge on a capacity-optimizing solution.

13. The system of claim 9, wherein the updated parameter estimate is calculated using a function that places a greater weight on the previous parameter estimate than the received signal.

14. The system of claim 9, wherein the updated parameter estimate is calculated for respective subcarriers according to the following equation
$${\hat{π}}_{n}^{k} = \frac{μ {\hat{π}}_{n}^{k - 1} + {r}_{n}^{k} {s}_{n}^{{k}^{*}}}{μ + {\vert {s}_{n}^{k} \vert}^{2}} , ∀ n = 0 , … , N - 1 ,$$
wherein superscript k, represents a time of receiving the signal and n denotes a given subcarrier among N total subcarriers of the channel, \hat{π}ₙ^{k} denotes the updated parameter estimate for the n^{th} subchannel, μ is a weighting parameter that is greater than one, r^{k} denotes the signal vector received at a given node, and rₙ^{k} is the n^{th} element of the received signal vector r^{k}, and sₙ^{k} and sₙ^{k}* are the n^{th} element and the complex conjugate of the n^{th} element of transmitted signal vector, s^{k}, respectively, and wherein s^{k} is known.

15. The system of claim 9, wherein the subcarrier weights for respective subcarriers are calculated according to a function for optimizing a capacity of the channel.

16. The system of claim 9, wherein the subcarrier weights for respective subcarriers are calculated according to the following equation:
$${\hat{g}}_{n}^{k} = \sqrt{\frac{{\vert {\hat{π}}_{n}^{k} \vert}^{2}}{{σ}_{n}^{2} + {\vert {\hat{π}}_{n}^{k} \vert}^{2}}} {( \frac{1}{{P}_{0}} {\sum }_{m = 0}^{N - 1} \frac{{\vert {\hat{π}}_{m}^{k} \vert}^{2}}{{σ}_{m}^{2} + {\vert {\hat{π}}_{m}^{k} \vert}^{2}} )}^{\frac{- 1}{2}} ∀ n = 0 , … , N - 1$$
wherein superscript, k, represents a time of receiving the signal,
n denotes a given subcarrier among N total subcarriers of the channel,
σₙ² is the noise variance of the n^{th} subchannel,
σₘ² is the noise variance of the m^{th} subchannel,
\hat{π}ₙ^{k} denotes the updated parameter estimated for the n^{th} subchannel, and
P₀ is the average of the available power at the node calculating the subcarrier weights.
